(19) United States
(12) Patent Application Publication
(10) Pub. No.: US 2019/0109656 A1
(43) Pub. Date: Apr. 11, 2019

(54) PASSIVE ULTRA LOW FREQUENCY TARGET TRACKER

(71) Applicant: Honeywell International Inc., Morris Plains, NJ (US)

(72) Inventor: Steven Tin, Plymouth, MN (US)

(21) Appl. No.: 15/729,336

(22) Filed: Oct. 10, 2017

(51) Int. Cl. H04B 17/27; H04B 13/02

(52) U.S. Cl. CPC H04B 17/27; H04B 13/02

(57) ABSTRACT

A tracker comprises at least one transmitter, wherein each transmitter comprises a substrate; a cantilever beam having a first end coupled to the substrate; at least one electret formed on, or by all or part of, the cantilever beam; at least one ground plane configured to be perpendicular to motion of the at least one electret, and wherein the at least one electret is configured to radiate an electromagnetic field, at a frequency corresponding to the resonant frequency of the transmitter, when vibrating energy is incident upon the transmitter.

### BACKGROUND

In a high frequency spectrum, communication of signals is well established. However, a signal communicated in the high frequency spectrum is easy to jam and cannot penetrate through conductive media such as water, metal, soil, rock, and building materials for a long distance (ex. over hundred meters). Signals in the ultra low frequency (ULF) spectrum, which ranges from 300 Hz to 3 kHz, are capable of penetrating such substances.

Some systems transmit signals in an ultra low frequency (ULF) spectrum to communicate with underground or underwater systems. For example, terrestrial communications communicate with submerged submarines using the ULF spectrum because signals in that frequency spectrum penetrate through water. Because the free-space wavelengths of electromagnetic fields at these frequencies are hundreds to thousands of kilometers in length, antennas used with ULF radios are either are either very inefficient or are very large. For example, ULF antennas may be up to 10 miles long.

It would be desirable to track assets using a ULF transmitter because the assets can be tracked below ground and underwater. However, inefficient or very long antennas used with ULF radios make this impractical. Therefore, there is a need for a small ULF transmitter which can be used to track assets.

### SUMMARY

A tracker comprises at least one transmitter, wherein each transmitter comprises a substrate; a cantilever beam having a first end coupled to the substrate; at least one electret formed on, or by all or part of, the cantilever beam; at least one ground plane configured to be perpendicular to motion of the at least one electret, and wherein the at least one electret is configured to radiate an electromagnetic field, at a frequency corresponding to the resonant frequency of the transmitter, when vibrating energy is incident upon the transmitter.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 describes one embodiment of a tracker;

FIG. 2A is an exemplary illustration of a mechanical vibration signature frequencies of a target;

FIG. 2B illustrates one embodiment of an ultra low frequency tracker including multiple transmitters;

FIG. 3 illustrates a block diagram of one embodiment of a system of a target and a receiver system;

FIG. 4A is a flow diagram of one embodiment of method of operation of a tracker; and

FIG. 4B is a flow diagram of one embodiment of method of operation of a tracker receiver system.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

A tracker is described herein that includes one or more transmitters. Each transmitter comprises a cantilever beam having at least one electret attached to it. An electret is a dielectric with an electric charge. The tracker is intended to be attached to a target, e.g. a machine such as a vehicle or manufacturing equipment, a human, or an animal. Vehicles include cars, trucks, trains, ships, submarines, aircrafts, helicopters, spacecrafts, or any other vehicles.

Vibrational energy, e.g. from the target, powers the transmitter(s) of the tracker. The target generates vibrational energy when it moves, such as when a vehicle is in motion, or a vehicle's engine or a machine (such as a generator) is operating. Alternatively, vibrational energy from the environment where the target is located can provides such vibrational energy; for example, vibrational energy from nearby machinery. The vibrational energy causes the transmitter(s) to oscillate at their resonant frequenc(ies). In one embodiment, the resonant frequenc(ies) are designed to oscillate a ULFs. When the transmitter(s) oscillate, the electret(s) of each transmitter generates an electromagnetic field (signal) in frequency spectrum at the resonant frequenc(ies). In one embodiment, the resonant frequenc(ies) are in the ULF spectrum; however, the resonant frequencies can be in other frequency spectrums.

A receiver can detect the signal, and determine that the target, or its environment, is generating vibrational energy. This may indicates that the target is moving. A system of three or more receivers can determine the location of the target.

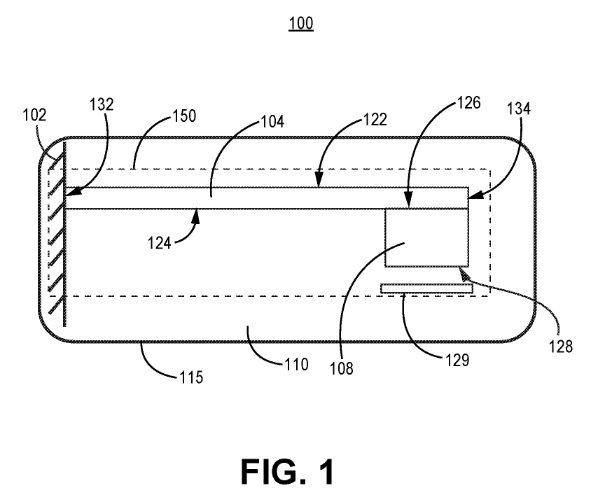

FIG. 1 describes one embodiment of a tracker 100. The tracker 100 includes at least one transmitter 150. Each transmitter 150 comprises a cantilever beam 104 and at least one electret 108 formed on the cantilever beam 104. In another embodiment, the cantilever beam 104 may be, in whole or in part, the electret 108. The cantilever beam 104 has a first surface 122, a second surface 124 opposite the first surface 122, a first end 132, and a second end 134 opposite the first end 132. In one embodiment, the cantilever beam 104 is integrated with a substrate 102 at the first end 132 of the cantilever beam 104. In another embodiment, the cantilever beam 104 is fabricated from, e.g., the material comprising the semiconductor substrate such as silicon.

The transmitter 150 includes at least one electret 108 formed on the cantilever beam 104. An electret 108 has a third surface 126, and a fourth surface 128 opposite the third surface 126. In one embodiment, one electret 108 is formed on the cantilever beam 104 to align with a second end 134 of the cantilever beam 104 such that the third surface 126 of electret 108 is formed on at least a portion of the second surface 124 of the cantilever beam 104. Although FIG. 1 illustrates a single electret 108 being formed on the cantilever beam 104, more than one electret can be formed on the cantilever beam 104. In another embodiment, the at least one electret 108 is fabricated from a dielectric such as silicon dioxide. In a further embodiment, the at least one transmitter 150 is fabricated as a microelectromechanical system (MEMS), e.g. using semiconductor manufacturing techniques.

At least one ground plane 129 is placed perpendicular to motion of the electret 108; the at least one ground plan 129 is coupled to electrical ground. In one embodiment the at least one ground plane 129 is a metal, such as gold. In another embodiment, the at least one ground plane 129 is formed on the substrate 102. In a further embodiment, the at least one ground plane 129 is the ground plane(s) closest to the electret 108.

In one embodiment, the tracker 100 further comprises a housing 115. The at least one transmitter 150 is attached to the housing 115, e.g. by attaching, by using an adhesive material such as epoxy or solder, the substrate 102 to the housing 115. In another embodiment, the at least one transmitter 150 is hermetically sealed within the housing 115. In a further embodiment, a vacuum 110 is formed within the hermetically sealed housing. The vacuum 110 filters out all signals (such as acoustic signals) except vibrational energy transferred from the target to the tracker 100. When the at least one transmitter 100 is formed as MEMS and placed in a vacuum, the at least one transmitter 150 could achieve a very high Q factor of greater than 100,000. As a result, it more efficiently translates vibrational energy into the signal.

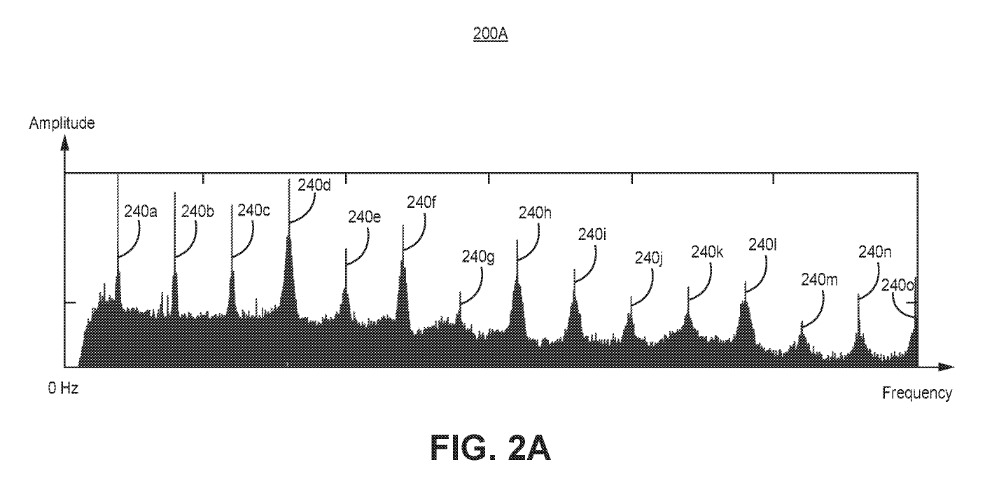

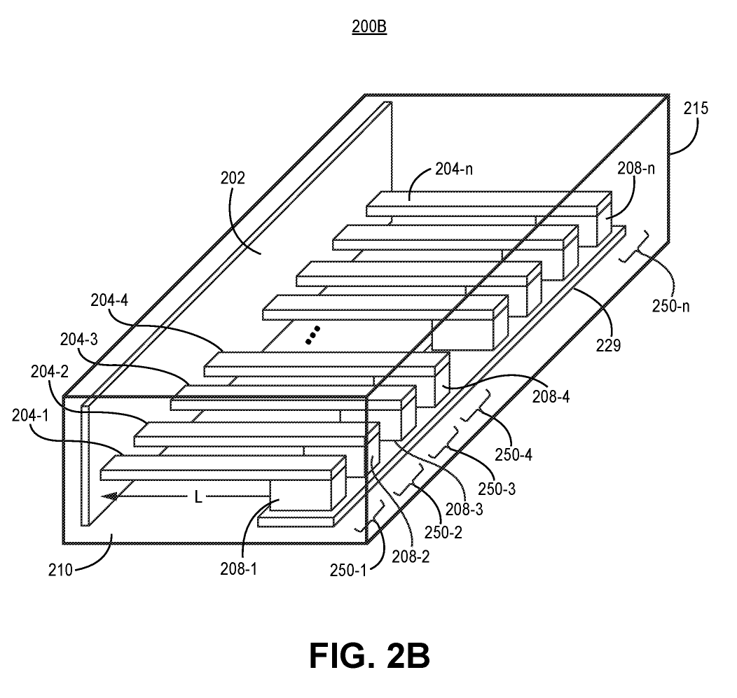

FIG. 2A is an exemplary illustration of a mechanical vibration signature frequencies of a target (target signature frequencies) 200A. The target, or its environment, generate vibrational signals above zero hertz through, e.g. at least the ULF spectrum. The tracker signature frequencies 200A have pronounced signals 240a-o. The pronounced signals 240a-o may be a resonant frequency and its harmonics, for example some or all of which are in the ULF spectrum, generated by the target. The tracker 100 operates more efficiently if its transmitters 150 are designed to resonate at pronounced signals 240a-o of the tracker signature frequencies 200A. For pedagogical purposes, the tracker signature frequencies comprise more than one frequency; however only one frequency may be used.

Returning to FIG. 1, transmitters 150 can be designed to have resonant frequencies corresponding to the pronounced signals, e.g. in the ULF spectrum, of a target to which they will be attached. The resonant frequencies can be designed, e.g. using finite element analysis modelling tools, by selecting material composition (i.e. corresponding Young's modulus) and appropriate dimensions of each of the cantilever beam 104 and the corresponding electret(s) 108.

As a transmitter 150, of a tracker 100, vibrates at its resonant frequency, the electret(s) 108, and thus the transmitter 150 and the tracker 100, generate an electromagnetic signal at the corresponding resonant frequency. If the tracker 100 has transmitters 150 with more than one resonant frequency, then the tracker 100 generates electromagnetic signals having more then one frequency component. In one embodiment, those one or more frequency components are in the ULF spectrum.

FIG. 2B illustrates one embodiment of an ultra low frequency tracker including multiple transmitters (tracker) 200B. Each transmitter 250-x of the tracker 200B includes an electret 208-x formed on a beam 204-x, and functions in a manner similar to the transmitter 150 described with respect to FIG. 1. One electret 208 formed on the beam 204 will be illustrated for pedagogical reasons; however, the electret 208-x can be implemented as described above with respect to FIG. 1. In the illustrated embodiment, the cantilever beams 204-1 to 204-n are coupled to a single substrate 202. In a further embodiment, the cantilever beams 204-1 to 204-n are parallel to one another.

At least one ground plane 229 is placed perpendicular to the motion of the electrets 208-1 to 208-n. In one embodiment, groups of one or more electrets can have separate ground planes. For pedagogical reasons, FIG. 2B illustrates a single ground plane. Each of the at least one ground plan 229 is coupled to electrical ground. In another embodiment, each of the at least one ground plane 229 is a ground plane closest to the corresponding electret 208-x.

In one embodiment, the transmitters 250-1 to 250-n are configured to vibrate, and generate signal comprised of one or more frequencies of pronounced signal of the target. In another embodiment, the one or more frequencies are all, or partially, in the ULF spectrum. In a further embodiment, the length L of one or more groups of cantilever beams may vary to change resonant frequencies of transmitters in the group(s), where the cantilever beams of each group has the same resonant frequency. Alternatively, some or all dimensions (other then just length L) of the cantilever beam and/or electret, and/or their materials may be changed to affect change in transmitter resonant frequencies. In yet another embodiment, if a group comprising transmitters 250 having the same resonant frequency, and each cantilever beam of the transmitter 250 in such group vibrate in phase, then the electromagnetic energy generated by each of the corresponding transmitters will be summed so as to increase the electromagnetic energy of the signal at the corresponding resonant frequency. As a result, tracker 200B signal power is increased at such resonant frequency, and a receiver can detect electromagnetic signal from the tracker 200B at this frequency at a greater distance.

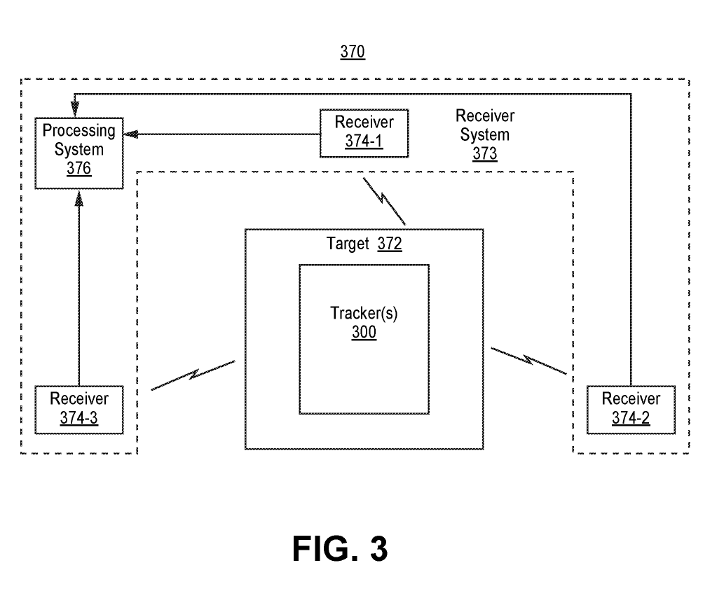

FIG. 3 illustrates a block diagram of one embodiment of a system of a target and a receiver system (system) 370. One or more trackers (tracker(s)) 300 are attached to the target 372. The tracker(s) 300 may be attached by mechanical means, e.g. screws, or chemical means, e.g. an adhesive. In one embodiment, the size of each tracker 300 is significantly smaller than the size of the target 372.

In one embodiment, the receiving system 373 comprises one or more receivers 374-x, each of which is coupled to a processing system 376. The processing system 376 is a state machine, e.g. a processor coupled to a memory. The processing system 376 analyzes signals detected by each receiver 374-x. In another embodiment, such analysis is performed by software, stored in the memory, and executed by the processor. In a further embodiment, the processing system 376 stores geographic data, e.g. in a database for example stored in the memory. The processing system is configure to display or communicate information, e.g. whether the tracker is generating a signal, the range of the tracker from each receiver, and/or possibly even information about the location and movement of the tracker(s) 300 and thus the target 372. Such information may be displayed by a display, e.g. a touch screen, which is coupled to the state machine, e.g. the processor. Such information may be communicated by a communications system, such as a modem or a radio, which is also coupled to the state machine, e.g. the processor.

FIG. 3 illustrates a receiving system 373 comprising three receivers 374-1, 374-2, 374-3. When a single receiver 374-x detects target signature frequenc(ies), this signifies that the target 372 is generating vibrational energy. Further, the amplitude of the target signature frequenc(ies), detected by at least one receiver 374-x, may be analyzed, e.g. by the state machine, to estimate the range of the target 372. Such analysis may be performed by knowing the radiated power of the tracker(s) 300 with respect to frequency, and estimating propagation distance using a propagation model, such as the Hata model or a propagation model using free space path loss.

Typically, a single receiver 374-x can not determine location of the target 372, or whether the target is moving. However, if at least three spatially diverse receivers 374-x are used, the processing system 376 determines a circular perimeter around the geographic location of each receiver 374-x, where (a) radii of the circular perimeters are proportional to the relative magnitudes detected by the corresponding receivers 374-x, and (b) the circular perimeters intersect at one point. In one embodiment, the radii are determined using the technique described above to estimate range. This point of intersection is the location of the target 372 to which the tracker(s) 300 are attached. Using this technique, both the location and movement of a target 372 with tracker(s) 300 can be monitored by the receiving system 373.

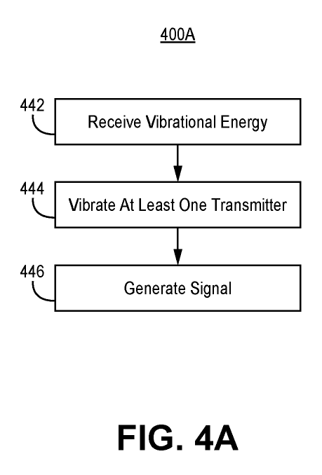

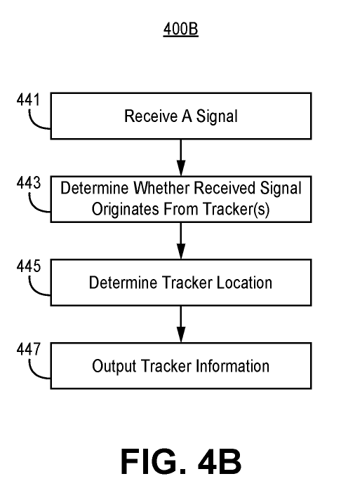

FIG. 4A is a flow diagram of one embodiment of method of operation of a tracker 400A. To the extent that the embodiment of method 400A shown in FIG. 4A is described herein as being implemented in the systems shown in FIGS. 1 through 3, it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figure) can occur in a different order (for example, where at least some of the processing associated with the blocks is performed in parallel and/or in an event-driven manner).

In block 442, receive vibrational energy by at least one transmitter. In one embodiment, receiving vibrational energy comprises receiving vibrational energy from a target. In another embodiment, the received vibrational energy, from the target, comprises target signature frequenc(ies).

In block 444, vibrate at least one transmitter, where each transmitter vibrates at a resonant frequency. In one embodiment, vibrate at least one transmitter comprises vibrate at least one cantilever beam with at least one electret formed on the cantilever beam. In another embodiment, vibrate, at the same resonant frequencies, two or more transmitters. In a further embodiment, vibrate two or more groups of one or more transmitters, where each group vibrates at a different resonant frequency. In yet another embodiment, vibrate the at least one transmitter at the target signature frequenc(ies).

In block 446, radiate an electromagnetic field, electromagnetic signal, or signal. In one embodiment, the radiated signal is in the ULF spectrum. In another embodiment, the radiated signal comprises or consists of at least one resonant frequency. In a further embodiment, the radiated signal comprises at least one target signal frequency.

FIG. 4B is a flow diagram of one embodiment of method of operation of a tracker receiver system 400B. To the extent that the embodiment of method 400B shown in FIG. 4B is described herein as being implemented in the systems shown in FIGS. 1 through 3, it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figure) can occur in a different order (for example, where at least some of the processing associated with the blocks is performed in parallel and/or in an event-driven manner).

In block 441, receive a signal at at least one receiver. In one embodiment, the signal is in the ULF spectrum. In block 443, determine whether the received signal is from at least one tracker. In one embodiment, perform signal processing on the received electromagnetic signal, e.g. in the processing system 376, to determine whether the received signal originates from the at least one tracker, or originates from another source, such as a noise source. In another embodiment, perform such determination, e.g. with the processing system 376, by comparing the received signal with a database of signals corresponding to the frequencies emitted by trackers, such as their corresponding target signal frequenc(ies). The confidence of detecting specific tracker(s), and the target to which they are attached, increases as the number of frequency components in the target signal frequenc(ies) is increased.

In block 445, if the received signal is determined to be from at least one tracker, and is received by at least three spatially diverse receivers, determine the location, and possibly the movement of the tracker, and thus the target to which the tracker is, e.g. attached. Tracker location may be determined, e.g. by the technique, described above. Movement can be determined by determining location over time.

In block 447, in an optional embodiment, output tracker information, e.g. such as displaying, or transmitting (e.g. to another system), information about the tracker corresponding to the received vibrational energy, including tracker identification and/or target identification, distance of tracker from a receiver, tracker location and/or tracker movement.

Terms of relative position as used in this application are defined based on a plane parallel to, or in the case of the term coplanar—the same plane as, the conventional plane or working surface of a layer, wafer, or substrate, regardless of orientation. The term “horizontal” or “lateral” as used in this application are defined as a plane parallel to the conventional plane or working surface of a layer, wafer, or substrate, regardless of orientation. The term “vertical” refers to a direction perpendicular to the horizontal. Terms such as “on,” “side” (as in “sidewall”), “higher,” “lower,” “over,” “top,” and “under” are defined with respect to the conventional plane or working surface being on the top surface of a layer, wafer, or substrate, regardless of orientation. The term “coplanar” is defined as a plane in the same plane as the conventional plane or working surface of a layer, wafer, or substrate, regardless of orientation.

### EXAMPLE EMBODIMENTS

Example 1 includes a tracker comprises: at least one transmitter, wherein each transmitter comprises: a substrate; a cantilever beam having a first end coupled to the substrate; at least one electret formed on, or by all or part of, the cantilever beam; at least one ground plane configured to be perpendicular to motion of the at least one electret, and wherein the at least one electret is configured to radiate an electromagnetic field, at a frequency corresponding to the resonant frequency of the transmitter, when vibrating energy is incident upon the transmitter.

Example 2 includes the tracker of Example 1, wherein the cantilever beam has a second end opposite the first end, a first surface, and a second surface opposite the first surface; wherein the electret has a third surface, and a fourth surface opposite the third surface; and wherein the electret is formed on the at least a portion of the second surface at the second end.

Example 3 includes the tracker of any of Examples 1-2, wherein the frequency is in the ultra low frequency spectrum.

Example 4 include the tracker of any of Examples 1-3, wherein the vibrating energy comprises at least one signature frequency; and the at least one transmitter generates an electromagnetic field having at least one frequency that is the at least one signature frequency.

Example 5 includes the tracker of Example 4, wherein the at least one transmitter comprises at least two groups of transmitters; and wherein transmitters of each of the at least two groups have different resonant frequencies.

Example 6 includes the tracker of any of Examples 1-5, wherein each transmitter is configured to vibrate upon receipt of vibrational energy.

Example 7 includes the tracker of any of Examples 1-6, wherein the cantilever and substrate comprise a semiconductor.

Example 8 includes the tracker of any of Examples 1-7, wherein the electret comprises silicon dioxide.

Example 9 includes the tracker of any of Examples 1-8, further comprising a housing which is hermetically sealed and encloses, in a vacuum, the at least one transmitter.

Example 10 includes a method comprising: receiving vibrational energy by at least one transmitter; vibrating the at least one transmitter, wherein each transmitter comprises a cantilever beam and at least one electret attached to the cantilever beam and wherein each transmitter vibrates at a resonant frequency; and radiating an electromagnetic signal comprising at least one frequency, wherein each of the at least one frequency is a resonant frequency of each of the at least one transmitter.

Example 11 includes the method of Example 10, wherein receiving the vibrational energy comprises receiving vibrational energy from a target.

Example 12 includes the method of Example 11, wherein receiving the vibrational energy from the target comprises receiving vibrational energy comprising at least one target signature frequency.

Example 13 includes the method of any of Examples 10-12, wherein vibrating the at least one transmitter comprises vibrating each of a two or more groups transmitters at a different resonant frequency.

Example 14 includes the method of any of Examples 10-13, wherein vibrating the at least one transmitter comprises vibrating at least two transmitters at the same resonant frequency.

Example 15 includes the method of any of Examples 10-14, where in vibrating the at least one transmitter comprises vibrating the at least one transmitter at least one target signature frequency.

Example 16 includes the method of any of Examples 10-15, wherein radiating an electromagnetic signal comprise radiating an electromagnetic signal in an ultralow frequency spectrum.

Example 17 includes a method, comprising: receiving an electromagnetic signal at at least one receiver; determining whether the received electromagnetic signal was transmitted from at least one tracker; and if the received electromagnetic signal is determined to be from at least one tracker, and is received by at least three spatially divers receivers, then determining information about at least one of: tracker location and tracker movement.

Example 18 includes the method of Example 17, wherein receiving the electromagnetic signal comprises receiving the electromagnetic signal in an ultralow frequency spectrum.

Example 19 includes the method of any of Examples 17-18, wherein determining whether the received electromagnetic signal was transmitted from the at least one tracker comprises comparing the received electromagnetic signal with a database of signals.

Example 20 includes the method of any of Examples 17-19, further comprising displaying or communicating information about at least one of tracker.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

What is claimed is:

1. A tracker comprises:
at least one transmitter, wherein each transmitter comprises:
a substrate;
a cantilever beam having a first end coupled to the substrate;
at least one electret formed on, or by all or part of, the cantilever beam;
at least one ground plane configured to be perpendicular to motion of the at least one electret, and
wherein the at least one electret is configured to radiate an electromagnetic field, at a frequency corresponding to the resonant frequency of the transmitter, when vibrating energy is incident upon the transmitter.

2. The tracker of claim 1, wherein the cantilever beam has a second end opposite the first end, a first surface, and a second surface opposite the first surface;
wherein the electret has a third surface, and a fourth surface opposite the third surface; and
wherein the electret is formed on the at least a portion of the second surface at the second end.

3. The tracker of claim 1, wherein the frequency is in the ultra low frequency spectrum.

4. The tracker of claim 1, wherein the vibrating energy comprises at least one signature frequency; and
the at least one transmitter generates an electromagnetic field having at least one frequency that is the at least one signature frequency.

5. The tracker of claim 4, wherein the at least one transmitter comprises at least two groups of transmitters; and
wherein transmitters of each of the at least two groups have different resonant frequencies.

6. The tracker of claim 1, wherein each transmitter is configured to vibrate upon receipt of vibrational energy.

7. The tracker of claim 1, wherein the cantilever and substrate comprise a semiconductor.

8. The tracker of claim 1, wherein the electret comprises silicon dioxide.

9. The tracker of claim 1, further comprising a housing which is hermetically sealed and encloses, in a vacuum, the at least one transmitter.

10. A method comprising:
receiving vibrational energy by at least one transmitter;
vibrating the at least one transmitter, wherein each transmitter comprises a cantilever beam and at least one electret attached to the cantilever beam and wherein each transmitter vibrates at a resonant frequency; and
radiating an electromagnetic signal comprising at least one frequency, wherein each of the at least one frequency is a resonant frequency of each of the at least one transmitter.

11. The method of claim 10, wherein receiving the vibrational energy comprises receiving vibrational energy from a target.

12. The method of claim 11, wherein receiving the vibrational energy from the target comprises receiving vibrational energy comprising at least one target signature frequency.

13. The method of claim 10, wherein vibrating the at least one transmitter comprises vibrating each of a two or more groups transmitters at a different resonant frequency.

14. The method of claim 10, wherein vibrating the at least one transmitter comprises vibrating at least two transmitters at the same resonant frequency.

15. The method of claim 10, wherein vibrating the at least one transmitter comprises vibrating the at least one transmitter at least one target signature frequency.

16. The method of claim 10, wherein radiating an electromagnetic signal comprise radiating an electromagnetic signal in an ultralow frequency spectrum.

17. A method, comprising:
receiving an electromagnetic signal at at least one receiver;
determining whether the received electromagnetic signal was transmitted from at least one tracker; and
if the received electromagnetic signal is determined to be from at least one tracker, and is received by at least three spatially divers receivers, then determining information about at least one of: tracker location and tracker movement.

18. The method of claim 17, wherein receiving the electromagnetic signal comprises receiving the electromagnetic signal in an ultralow frequency spectrum.

19. The method of claim 17, wherein determining whether the received electromagnetic signal was transmitted from the at least one tracker comprises comparing the received electromagnetic signal with a database of signals.

20. The method of claim 17, further comprising displaying or communicating information about at least one of tracker.
